(19) United States
(12) Patent Application Publication
(10) Pub. No.: US 2021/0122564 A1
(43) Pub. Date: Apr. 29, 2021

(54) Self-Loading Container

(71) Applicants: Jan CHABOT, Pointe-Claire (CA); LOCAL NET HOLDINGS, INC., Reading, PA (US)

(72) Inventor: Jan Chabot, Pointe-Claire (CA)

(21) Appl. No.: 17/050,597

(22) PCT Filed: Apr. 26, 2019
(86) PCT No.: PCT/US19/29340

§ 371 Date: Oct. 26, 2020

(51) Int. Cl. B65D 90/00; B65D 90/14; B65D 90/18; B66F 3/02; B60P 1/64; B60P 7/08; B60P 7/13; B60P 7/14

(52) U.S. Cl. CPC B65D 90/0033; B65D 90/14; B65D 90/18; B66F 3/02; B66F 2700/03; B60P 7/0892; B60P 7/13; B60P 7/14; B60P 1/6427

(57) ABSTRACT

A self-loading container with specific improvements upon prior art. The aim is to expand self-loading from industrial multi mode shipping units to less costly end uses with a range of container sizes, shapes and customizations that perform common tasks and that can be self-loaded into any size vehicle. Gravitational stability is improved by relocating the main rolling means of container from the bottom of vertically extendable jacks or legs to horizontally extendable support rails directly under container. As such, extendable legs are used only to vertically level container with a receiving surface onto which it can then be horizontally transferred by means of its horizontally extendable support rails. Cost and operating improvements include a simplified coupling mechanism torqued for heavy loads with which front and rear leg extension and retraction can be either in pairs, combined or locked.

### TECHNICAL FIELD

The present container relates broadly to loadable objects like mobile shipping containers and industrial housing units with mechanisms for self loading them onto transporting means and or fixed surfaces, and unloading from same, without manual lifting or the use of external lifting equipment. Most such means and surfaces are not roofed.

More specifically, it relates to containers and container like products adapted to be self-loaded into and unloaded from roofed vehicles such as closed body trucks, capped pickups, cargo and minivans and SUVs by one individual, and customizable for a range of varied uses and at lower costs to manufacture and operate.

It excludes exterior devices for loading and unloading that are not incorporated in loadable objects, such as cranes, fork and platform lifts, tow motors, ramp devices, etc. Excluded as well are loading devices mounted in or on transporting means or fixed surfaces to retrieve, or help retrieve, loadable objects from ground or other levels.

Prior art for self loadable objects is exemplified below. In one end of the spectrum, major shipping containers and mobile housing units with hydraulic lifting means dominate prior art. In the other end is found a smaller segment of prior art with smaller sized self loading products, like shopping carts, ambulatory stretchers and the like, using mechanical or manual self loading means.

### BACKGROUND—PRIOR ART

The following is a tabulation of some prior art that presently appears relevant:

| U.S. Pat. No. | Date Published | Patentee or Applicant |
|---|---|---|
| U.S. Pat. No. 2,688,881 | Sep. 14, 1954 | Crossland |
| U.S. Pat. No. 2,937,879 | May 24, 1960 | Lion |
| U.S. Pat. No. 4,369,985 | Jan. 25, 1983 | Bourgraf |
| U.S. Pat. No. 4,392,662 | Jul. 12, 1983 | Hoeglinger |
| U.S. Pat. No. 5,395,201 | Mar. 7, 1995 | Yamashita |
| U.S. Pat. No. 6,070,899 | Jun. 6, 2000 | Gines |
| U.S. Pat. No. 6,409,186 | Jun. 25, 2002 | Bennington |
| U.S. Pat. No. 7,811,044 | Oct. 12, 2010 | Warhurst |
| U.S. Pat. No. 8,011,035B2 | Sep. 6, 2011 | Spadoni |
| U.S. Pat. No. 8,550,274 | Oct. 8, 2013 | Gerdling |
| U.S. Pat. No. 8,950,603 B2 | Feb. 10, 2015 | Davis |
| U.S. Pat. No. 9,004,454 | Apr. 14, 2015 | Faure |
| U.S. Pat. No. 9,039,040 B2 | May 26, 2015 | Zhang |
| U.S. Pat. No. 9,233,699 | Jan. 13, 2016 | Murphy |

| Foreign Pat # | Date Published | Patentee or Applicant |
|---|---|---|
| WO1994004442A1 | Mar. 3, 1994 | Hadland |
| WO2004074136A1 | Sep. 1, 2004 | Knight |
| CN103318803A | Sep. 25, 2013 | Zeng Yibin |
| CN103626077B | Dec. 16, 2015 | Shi Yi |
| KR20160137304A | Nov. 30, 2016 | Gu Yeong Hui |

Prior Art is generally found in these categories:
1. Self-loading containers for use in transport systems, including among others:
(a) Large shipping containers subject to ISO standard rules for transport and handling. Such containers are designed and bunt for intermodal freight transport, ship to rail to flat bed truck and vice versa.
(b) Similar containers that are alternatively converted to be used as mobile shelters or offices, often for construction and for use in emergency stricken areas, and most often carried on flat bed trucks or trailers.
   The majority of both such container categories that incorporate their own lifting devices use pneumatic, hydraulic or mechanical jack type legs attached to their four corners. The legs raise the container sufficiently to allow a flatbed truck or other transporter to locate itself under the raised container, after which the container is lowered to rest on the transporter. The legs are then retracted and remain part of the container for later unloading. Other than cost, size and operating complexities, these containers have the additional disadvantage of only being loadable onto flatbed trailers or other trucks with flat and open platforms. So even in smaller sizes, as designed they could not be loaded into any roofed vehicles.
   2. Self-loading non-ISO compliant and smaller containers on wheels, suitable for use with flatbeds and pickups, but often still not usable with roofed vehicles.

An early such example is U.S. Pat. No. 2,937,879A by Lion granted May 24, 1960. It is a closed container with doors and with two front and two rear legs that can be raised or lowered in pairs. However, it has costly design and complicated operating disadvantages that would not lend itself to general use and for loading into roofed vehicles i.e.:
a. Container can only be loaded onto a flatbed truck.
b. Highly complicated loading procedure described, with several interim steps of raising and lowering legs and moving transporter truck, plus up to 8 steps of manually attaching and detaching casters from legs to container bottom and back, alternately using casters as both main and auxiliary rolling means.
c. A removable safety leg needed for some loading operations.
d. No means shown to lock extendable legs into selected vertical positions.
e. Costly dog clutch for isolating or combining movement of front and rear legs.
f. Clutch and leg elevation shown as operated from opposite sides of container.
g. Custom machined casters needed, as standard casters cannot be used.
h. Proposed alternative hydraulic and pneumatic systems are costly to produce and install and need specially trained operators.

One of the earliest examples that uses fixed auxiliary rolling means for self-loading containers is U.S. Pat. No. 4,392,662 by Hoeglinger granted Jul. 1, 1983. It is also a closed container with two front and two rear legs that can be raised or lowered in pairs. It has swivel casters as its main rolling means attached to each of its four telescoping legs. To facilitate transfer onto a raised platform or a vehicle, an additional four auxiliary swivel casters are fixed on the bottom wall of container. To enable such horizontal transfer, the container end is substantially cantilevered for initial deposit onto platform. This patent has features that do not lend themselves well to simple and economic self-loading, such as:
a. Main rolling means on extended legs of cantilevered container gives it a high center of gravity, with inherent instability, when moved on horizontal surfaces.
b. A cantilevered container involves placing telescoping legs inwards from one container end. Elevating the loaded container now requires stronger legs, gears and more rotational shaft torque in one end of the container than the other.
c. Caster wheel bottoms on the telescoping legs must be retracted to be above or at least even with the auxiliary caster wheel bottoms to complete the horizontal transfer of container onto platform. That requires telescoping caster wheels to be set wide enough to clear container sides or auxiliary caster wheels to be higher or to be set lower than the fully retracted telescoping caster wheels, a costlier and less efficient design not reflected in the patent drawings.
   Otherwise, prior art has primarily produced self-loading products for very specific uses that are able to afford same. Most are complicated and costly to manufacture and would not be mechanically nor economically suitable to render more common objects self loading.
   3. Elevated ambulatory stretchers that can be loaded with their wheels retracted. There are many examples of prior art in this field, most using scissor legs devices, manually, mechanically or hydraulically powered. One such example is:

U.S. Pat. No. 8,011,035 B2 by Spadoni granted Sep. 6, 2011. Basically, it describes an upper carrying level and a lower wheeled level of a stretcher. Manually pushing the stretcher unit towards and against the rear of the ambulance will cause the lower wheeled level of stretcher to collapse towards the upper level. The now shallower stretcher assembly slides onto ambulance floor with the wheels of the lower level now supporting the stretcher on the ambulance floor. A mechanical option pulls stretcher into vehicle. This is a cursory summary with the actual design details much more intricate.

4. Miscellaneous other self-loading products, most using versions of the above stretcher design. They include shopping carts, trolleys, tool chests, etc. The majority depends on manual power to push them up against the rear of a vehicle to have their wheel frames with scissor legs collapse into a more compact shape. Such shape in turn allows the loadable object to be inserted into a vehicle together with its cargo. It avoids manual lifting, but not manual pushing, pulling and possible destabilizing of loaded cargo.

### SUMMARY OF PRIOR ART

Prior art that incorporates self loading means generally cites products for specialized uses, consequently with specialized devices for self loading. Many have their main rolling means on extended legs making their horizontal movement unstable. Furthermore, most of the self loading means cited by prior art are too complicated, heavy and costly for general or widespread use in making most commercial and consumer products self-loadable. Finally, prior art largely fails to integrate the control functions of manipulating, locking and powering lifting members individually or simultaneously. That negatively affects cost and adds complexity of operation, thereby limiting most common uses of self loading products.

### DISCLOSURE OF INVENTION

There is one segment of the self-loading industry segment that has barely been addressed by prior art. Namely, the need for inexpensive ways to make intermediate sized objects, like containers and container like products, self-loadable into the rears of roofed vehicles like closed body trucks, cargo and mini vans, SUVs and the like. Particularly so for objects that are too heavy or dangerous for individuals to load and unload manually. Commercially, that includes self loadable storage units, mobile furniture and equipment for the trades, machine shops, retail, display, exhibition, catering, local delivery, dunnage and shipping containers and even mobile commercial buildings. For the consumer market, that includes self loadable mobile storage units customized for sports teams, flea and farmers markets, travel, camping, hunting, fishing, picnics, tail gate parties and other recreational activities. These needs have been growing along with the increasing self-reliance and entrepreneurial spirit of society in general, together with increasing e-commerce and commercially prepared meals that require ever more specialized delivery capabilities.

What is proposed and claimed is a self-loading container that can be customized in terms of size, shape and function to be used in the above mentioned product categories with a range of embodiments and ramifications. The mechanical improvements over prior art proposed and claimed will lower production costs and make the self-loading products lighter and simpler to use by non-skilled operators. An additional claim involves a simpler and safer way to self load such products into vehicles and safely retain them during travel.

The drawings and detailed description thereof teach an economical way to customize, machine, assemble and operate self loading containers. Contributing to such economies is the use of a modular container assembly system, which is the subject of a separate patent application by the present inventor. The system creates lighter end products with interconnected contoured aluminum panels and end frames. Customizations to container interiors and exteriors can be reversibly and seamlessly attached to container walls without welding. This system can further lower costs by incorporating standard materials, parts and components that are generally, locally and economically available.

### BRIEF DESCRIPTION OF THE DRAWINGS

For a fuller understanding of the proposed self-loading container and examples of alternative ramifications and embodiments thereof, provided below is a list of reference numerals, a detailed description and the accompanying drawings wherein:

FIGS. 1A through 1H are orthogonal side views, showing the steps involved in self loading a container from ground level to inside a van cargo floor.

FIGS. 2A through 2F are perspective views of container exterior bottom showing horizontally extendable support rails with main rolling means and vertically extendable legs with optional auxiliary rolling means.

FIGS. 3A through 3K are orthogonal and perspective views of container interior bottom showing how horizontally extendable main rolling means are installed and manipulated.

FIGS. 4A through 4G are perspective views of the vertical extension functionalities of the container legs and their bottom attachment of optional auxiliary rolling means.

FIGS. 5A through 5F are perspective views of the gearing in self-loading container.

FIGS. 6A through 6I are orthogonal views of the three alternative coupling settings for manipulating and locking container legs extension and retraction for self-loading.

FIGS. 7A through 7I are perspective views of the three alternative coupling settings for manipulating and locking container legs extension and retraction for self-loading.

FIGS. 8A through 8H are orthogonal and perspective views of container self loaded into a van with an insertable cargo surface and retained by rails pivoting on said surface.

FIGS. 9A through 9F are perspective views of self loading containers with alternative functions and uses. They exemplify other ramifications of self loading container.

FIGS. 10A through 10E are perspective views of self loading platforms with alternative functions and uses. They exemplify other embodiments of self loading container.

### LIST OF REFERENCE NUMERALS FOR PARTS SHOWN IN DRAWINGS

For expediency, the first digit in a reference numeral, up to 9, and first two digits after that, identify the drawing sheet # where a referred part is first introduced:
210 Extendable Support Rail
212 Flange-Mount Swivel Stem Caster
214 Stud-mount Ball Transfer
216 Retractable Leg Housing
218 Support Rail Retainer Channel
220 Support Rail End Frame Cutouts
222 Support Rail Motion Stop
310 Container Bottom Wall Cutouts
312 Support Rail Operating Shaft
314 Support Rail Shaft Offset From Side Wall
316 Support Rail Spur Gear
318 Support Rail Rack
320 Flange-Mount Ball Transfer
410 Retractable Leg Gear Rack
412 Retractable Leg Spur Gear
414 Retractable Leg
416 Vertical Leg Extender
418 Ball Transfer Anchor
420 Retractable Leg Bottom Movement Stop
422 Leg Extender Exterior Stop Insert
424 Leg Extender Interior Stop Hole
426 Retractable Leg Top Movement Stop
428 Exterior Leg Lock
430 UHMW Friction Reducing Slick Strips—Optional
510 Rear Legs Operating Shaft
512 Coupling Interval Lock
514 Front Legs Operating Shaft
516 Front Legs Operating Shaft Miter Gear
518 Front Coupling Shaft
520 Rear Coupling Shaft
522 Coupling Operating Shaft
524 Coupling Operating Knob and Thrust Ball Bearing Combo
526 Front Coupling Shaft Worm Gear
528 Coupling Operating Shaft Front Worm
530 Rear Coupling Shaft Worm Gear
532 Coupling Operating Shaft Rear Worm
534 Low Profile Shaft Support Block
536 High Profile Shaft Support Block
610 Front Coupling Shaft Miter Gear
612 Rear Coupling Shaft Miter Gear
614 Coupling Front Lock Groove
616 Coupling Neutral Lock Groove
618 Coupling Operating Shaft Washer
810 Container In-Vehicle Retainer Rails
812 Retainer Rail Pivot Bolt
814 Retainer Rail Stop Bolt

### MODES FOR CARRYING OUT THE INVENTION

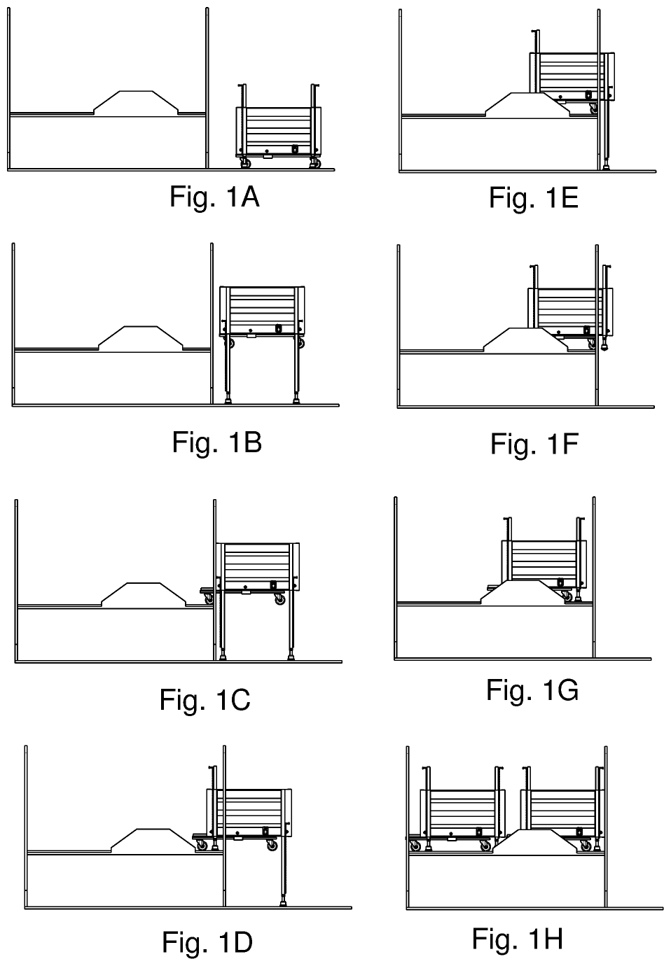

### Description—Sequential Steps in Self Loading—FIGS. 1A Through 1H

Self-loading of this container is accomplished by vertically manipulating two front jacks or legs and two rear jacks or legs in housings on the exterior sides of the container. It is further accomplished by horizontally manipulating two support rails in channels under the container. The horizontal rails anchor the main rolling means of container. The vertical legs may optionally have auxiliary rolling means on their bottom ends. Unloading requires performing the steps in reverse. All without manual lifting or external lifting means required. The support rails are extended from the container rear end, which end is loaded first.

FIGS. 1A through 1H are orthogonal side views, showing the steps involved in self-loading a container from ground level, or any other starting surface, to inside a van cargo floor or to any other receiving surface.

FIG. 1A shows container on ground level, supported by its main rolling means. This is the main operating position of container when moved horizontally on either the starting or the receiving surfaces. It provides the container with a low point of gravity and a solid base. To achieve this operating position, container legs are fully retracted simultaneously. The vertically retracted legs will now protrude above the top surface of container, thereby providing a convenient means for manually holding onto and horizontally moving the container on its main rolling means.

FIG. 1B shows container after it has first been moved to the rear opening of vehicle. The rear end of the container is now horizontally flush with the rear end of vehicle. Rear and front legs have simultaneously been extended to the point where the container main rolling means are now elevated to be horizontally level with the cargo floor of the vehicle.

The vehicle shown here has the dimensions of a full-size van. The depiction is schematic, showing only those elements defining its cargo area limits.

FIG. 1C shows the horizontal extension of the container support rails carrying its main rolling means, here depicted as swivel casters, the rear pair of which now rest on the vehicle cargo floor.

FIG. 1D shows the two rear legs fully retracted to be above the level of the main rolling means and vehicle cargo floor. Such retraction is possible, because the rear set of casters on the rails now rest on the cargo floor and carry the container rear end.

FIG. 1E shows the container now substantially pushed onto van cargo floor, while its front legs are still extended and resting on the ground or starting surface. Auxiliary rolling means on the bottoms of the front legs, as shown here, may be necessary for such a horizontal move. However, they are not necessary if weight of container front end is such that leg bottoms without auxiliary rolling means can slide on ground level, or starting surface, or that container front end can be manually lifted.

FIG. 1F shows container advanced onto van cargo floor to the point where its front legs can be fully retracted above the main rolling means and cargo van floor. This in turn allows container to now be fully advanced into van and totally resting on its main rolling means, here depicted as four swivel casters, all as shown in FIG. 1G. FIG. 1H shows a second container similarly self-loaded into van. While fully loaded, the container support rails remain horizontally extended. Such extension is minor compared to the length of the container, hence does not cause load imbalance.

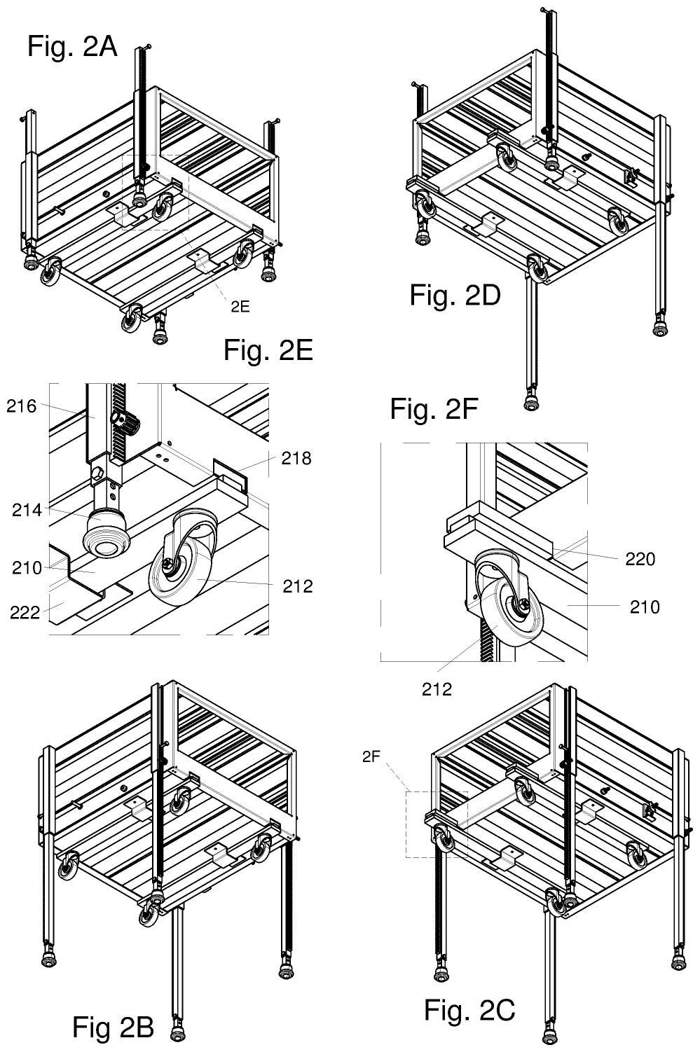

### Description—Main and Auxiliary Rolling Means—FIGS. 2A Through 4G

FIGS. 2A through 2F are perspective views of container exterior bottom showing horizontally extendable support rails with main rolling means and vertically extendable legs with optional auxiliary rolling means.

FIG. 2A shows bottom of container with both rear and front legs retracted vertically in its main operating position, as also shown on previous FIG. 1A.

FIG. 2B shows bottom of container with both rear and front legs vertically extended, as on previous FIG. 1B.

FIG. 2C shows bottom of container with both rear and front legs vertically extended, and the horizontally extended support rails with casters, as on previous FIG. 1C.

FIG. 2D shows bottom of container with rear legs vertically retracted and front legs extended, and the horizontally extended support rails with casters, as on previous FIG. 1D.

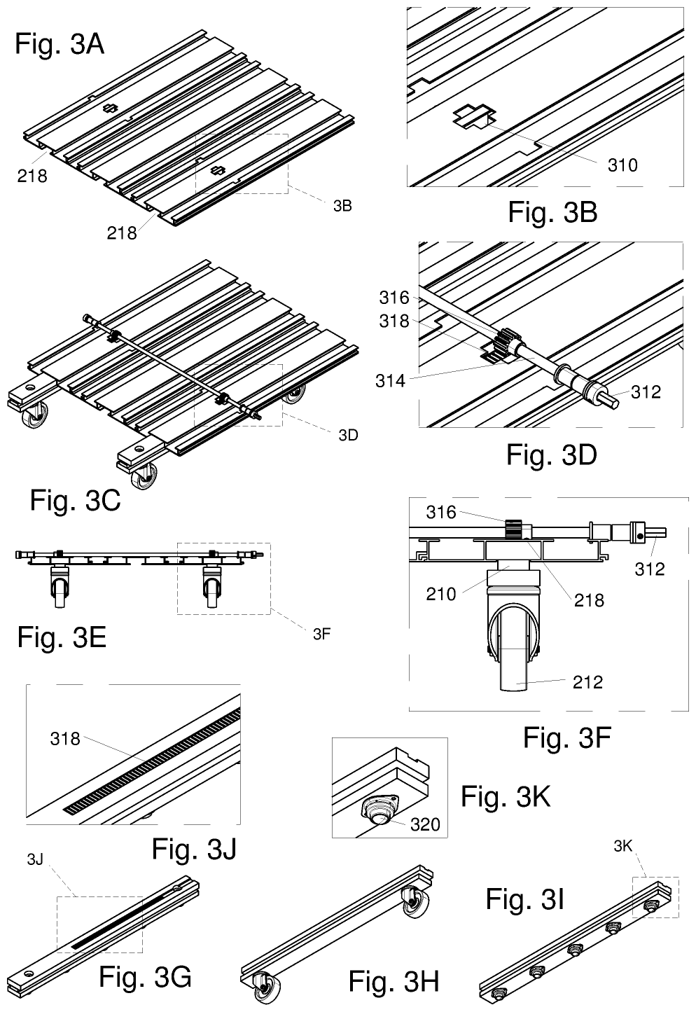

FIG. 2E details the vertically retracted rear leg and the horizontally retracted support rail 210 with flange-mount swivel stem casters 212 as the main rolling means. Rail 210 is vertically and horizontally retained and slides in support rail retainer channel 218 integrated in container bottom. Two support rail motion stops 222 wrap around rail 210 and are mounted on the exterior of container. Channel 218 is orthogonally further identified in subsequent FIG. 3A. Rail 210 is extended and retracted through support rail end frame cutout 220. Stud-mount ball transfer 214 is the optional auxiliary rolling means shown attached to the bottom of retractable leg in its leg housing 216.

FIG. 2F details the extended container support rail 210 with swivel stem casters 212. Container support rails 210 are dimensional lumber assemblies housed and sliding in container bottom wall panel channels that structurally retain support rails with their casters. Alternative materials for support rails 210 include metal or plastic extrusions or co-extrusions.

FIGS. 3A through 3K are orthogonal and perspective views of container interior bottom showing how horizontally extendable main rolling means are installed and manipulated.

FIG. 3A shows inside bottom wall of container, which is an assembly of slidingly interconnected panels with profile contours designed to retain longitudinal objects like dimensional lumber or parts of same. The two exterior panels have cutouts 310 as detailed in FIG. 3B for the gearing required to manipulate the extension of support rails 210.

FIG. 3C shows the installation of two extendable support rails 210 in the exterior channels of bottom panels, together with their manipulation gearing, further detailed in FIG. 3D. Support rail operating shaft 312 in its shaft offset from sidewall 314 controls spur gears 316. When shaft 312 is rotated, gears 316 will cooperate with support rail racks 318 in both support rails. This in turn will cause rails to extend or retract, all depending on the direction of rotation.

FIG. 3E is an orthogonal view of the crosswise or end profile of the bottom wall of container with both support rails inserted and vertically and horizontally retained. This is further detailed in FIG. 3F where rails 210 with casters 212 can be extended or retracted by rotation of shaft 312 causing gears 316 to move rails 210 in retainer channel 218.

FIGS. 3G, 3H and 3I, respectively, show a top view of support rail and two bottom views, one with casters as the main rolling means, the other with ball transfers. FIG. 3J details racks 318 inserted in the top surfaces of support rails and also support rail motion stop 320. FIG. 3K details flange mount ball transfers 320 as alternative main rolling means to swivel casters on the bottom of support rails.

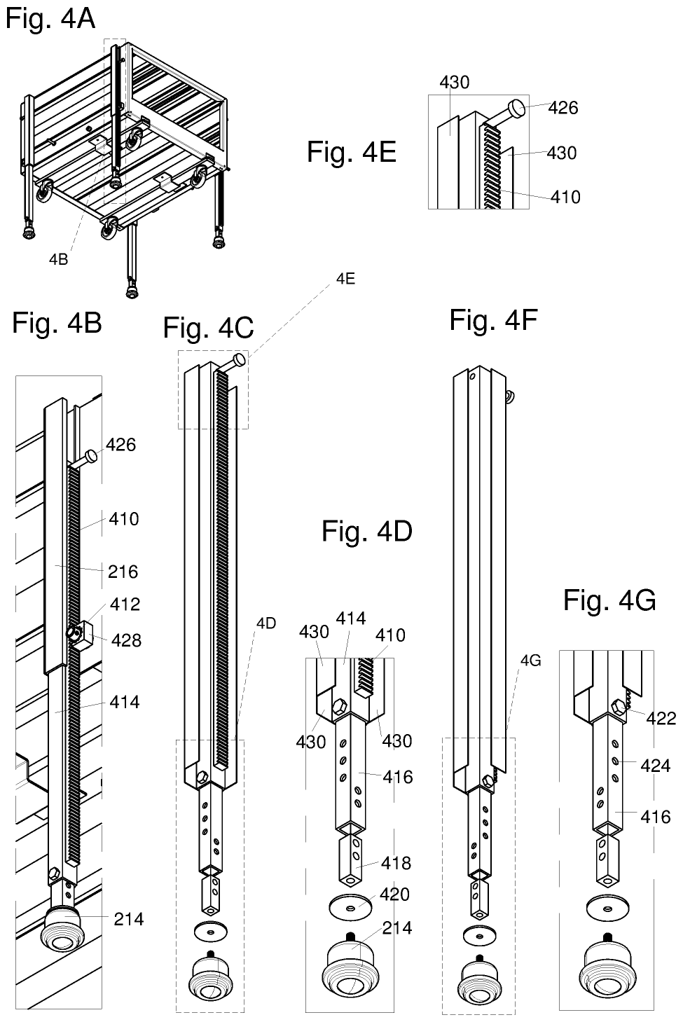

FIGS. 4A through 4G are perspective views of the vertical extension functionalities of the container legs and their bottom attachment of optional auxiliary rolling means.

FIG. 4A shows bottom of container facing rearwards with both rear and front legs extended, as on previous FIG. 1B.

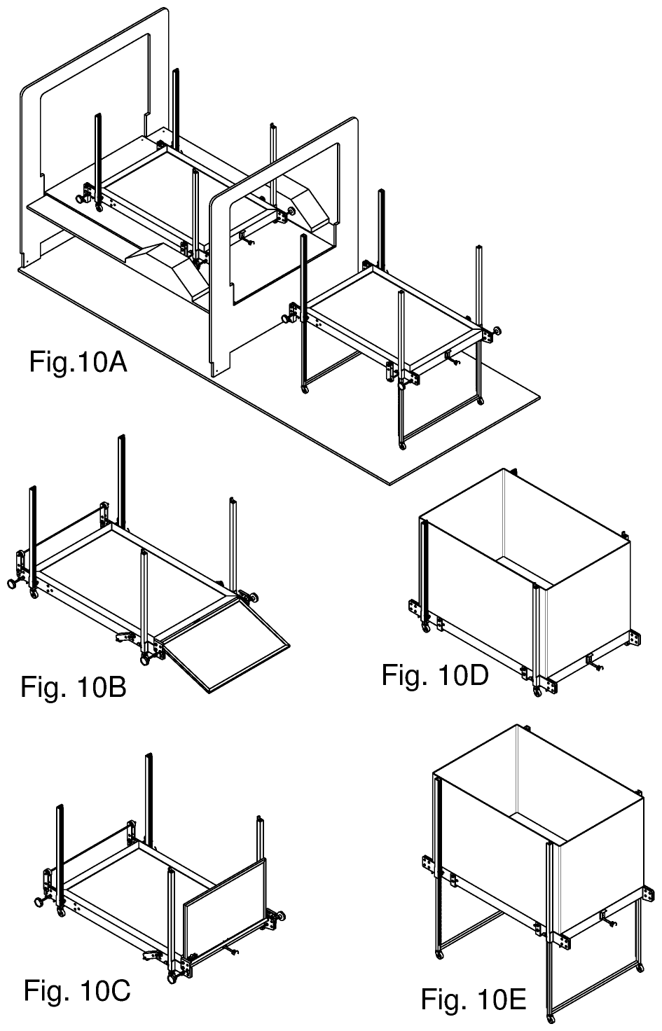

FIG. 4B details rear retractable leg section of container. It shows slotted leg housing 216 and ball transfer 214, gear rack 410, spur gear 412 and retractable leg 414. Gear rack 410 is attached to the one side of leg 414 that faces spur gear 412. Rack 410 slides in and protrudes out from a longitudinal slot in housing 216. FIG. 4B also shows exterior leg lock 428. It is only needed on the front and rear legs on one side, for locking them above the main rolling means as shown in previous FIGS. 10 and 1E. The exterior lock could be totally eliminated with a fourth coupling setting, not shown here.

FIG. 4C is an exploded view of rear retractable leg 414, further detailed in FIG. 4D. Stud-mount ball transfer 214 is threaded into ball transfer anchor 418, which is in turn attached to vertical leg extender 416. Retractable leg bottom movement stop 420 is retained between ball transfer 214 and anchor 418. It is a disk that limits the upward motion path of retractable leg 414. UHMW friction reducing slick strips 430 can optionally be adhered to the other three sides of leg 414 to ease its vertical movement.

FIG. 4E details the top part of retractable leg 414 with top of gear rack 410 and tops of strips 430. Retractable leg top movement stop 426 limits the downward motion path of retractable leg 414. FIGS. 4F and detailed 4G are different side views of FIGS. 4C and 4D, respectively. Leg extender exterior stop insert 422 and a series of interior stop holes 424 can be interconnected at different extension intervals for retractable leg 414. In addition to being retractable and extendable, legs 414 must also be able to be lengthened and shortened, achieved by telescoping interior vertical leg extender 416.

Adjustable leg length is needed when receiving surface is too high above or too low below starting surface, for retractable legs with their chosen length to elevate container sufficiently. It is also needed, when the top of vehicle rear opening, or of other loading opening, is not high enough above vehicle cargo floor to accept a container with retracted legs that protrude above its top at a height that exceeds the height of vehicle opening.

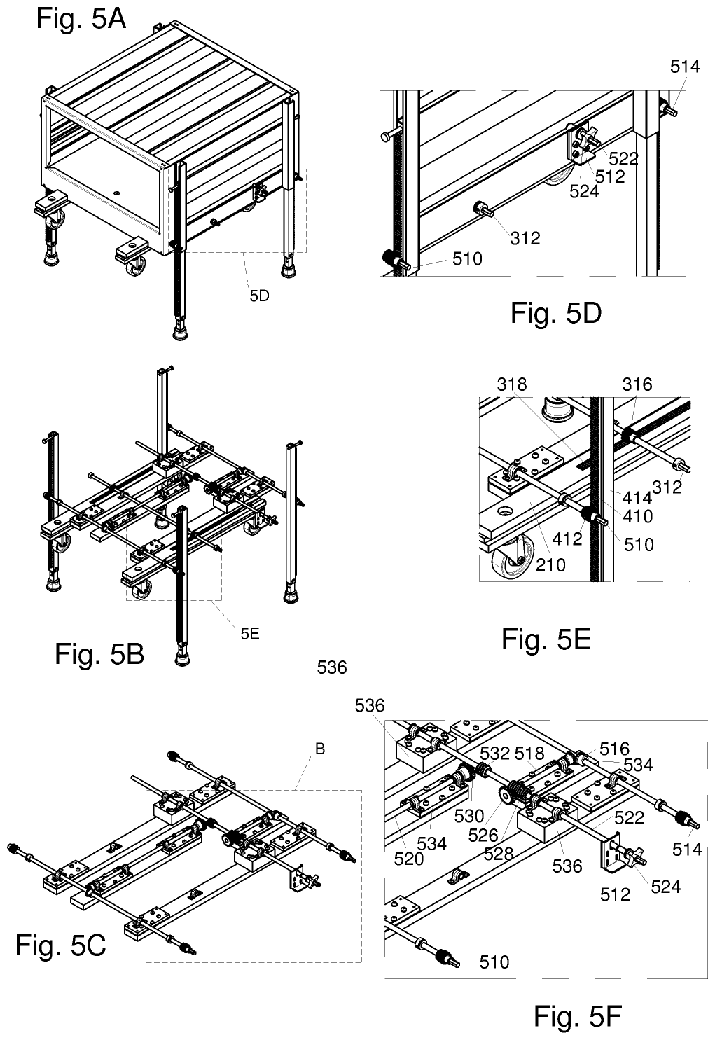

### Operation—Manipulation of Rolling Means—FIGS. 5A Through 7K

FIGS. 5A through 5F are perspective views of the gearing in self-loading container

FIG. 5A shows container with front and rear legs partly extended vertically, and with support rails extended horizontally. FIG. 5B shows the same except with container shell removed. FIG. 5C also removes the legs and rails, leaving only the leg manipulation parts.

FIG. 5D details the four locations where container legs can be vertically manipulated and its support rails with casters horizontally manipulated. FIG. 5E details the support rails gearing. FIG. 5F details the legs manipulation gearing. For operator convenience, visibility and safety, all manipulation points are on the same side of the container.

In FIG. 5D, the ends of rear legs operating shaft 510, front legs operating shaft 514, coupling operating shaft 522 and support rail operating shaft 312 all have hexagonal ends to accept attachment of exterior rotating means, such as a handheld battery powered drill or a flexible cable attached to such a drill. Rear shaft 510 and front shaft 514 each have exterior spur gears 412 attached that cooperate with gear racks 410 on retractable legs 414. Rotating rear shaft 510 will therefore retract or extend both rear legs. Similarly rotating front shaft 514 will therefore retract or extend both front legs. Clockwise rotation will extend legs and counterclockwise rotation will retract them.

In FIG. 5E, support rail operating shaft 312 has support rail spur gears 316 that cooperate with support rail racks 318 in the top surfaces of both support rails 210 for retraction or extension of same in unison. Clockwise rotation of shaft 312 extends rails and counterclockwise rotation retracts them. Retractable support rail motion stops 320 ensure that the maximum extension limit is not exceeded.

In FIG. 5F, front legs operating shaft miter gear 516 cooperates with a similar miter gear on front coupling shaft 518, perpendicular to front legs operating shaft 514. On its other end, shaft 518 has front coupling shaft worm gear 526 that can cooperate with coupling operating shaft front worm 528 on coupling operating shaft 522. Similarly, coupling operating shaft rear worm 532 can cooperate with rear coupling shaft worm gear 530 on rear coupling shaft 520. Shaft 520 has a miter gear on its other end that cooperates with a similar miter gear on rear legs operating shaft 510.

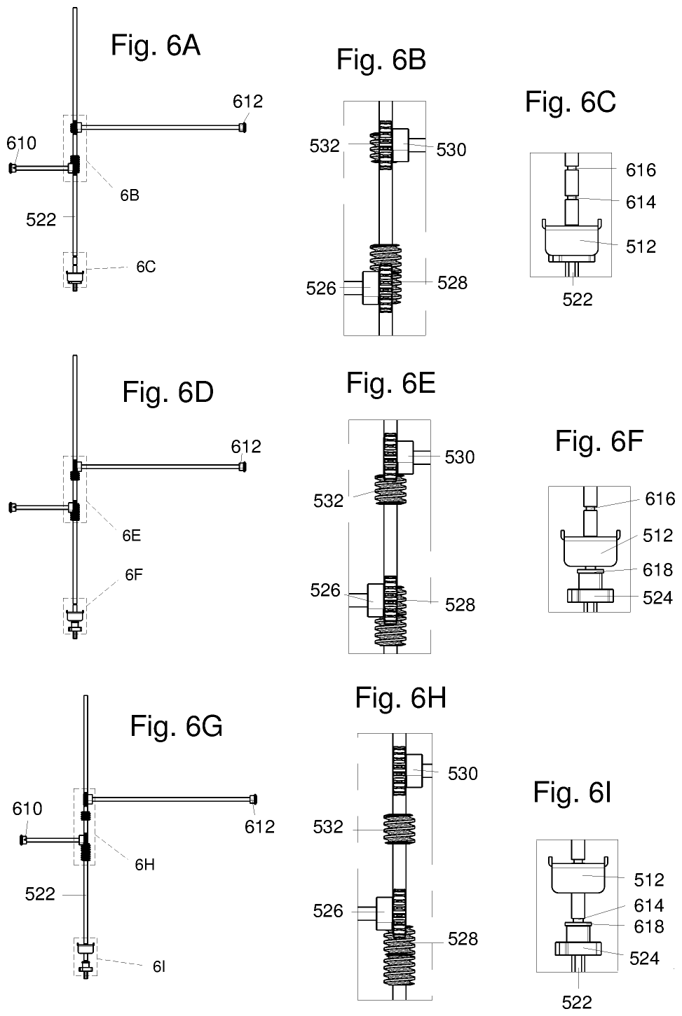

In FIG. 5F, shaft 522 is shown in its Neutral, or least forward, setting whereby there is no cooperation between worm 528 and worm gear 526 nor between worm 532 and worm gear 530. As such, the container front leg pair can be independently manipulated by rotating shaft 514 and the rear leg pair by rotating shaft 510. Shaft 522 is shown as locked into this neutral setting by rotating backwards coupling operating knob and thrust ball bearing combo 524 until coupling interval lock 512 can vertically be displaced into a circumferential groove in shaft 522. That groove is identified as coupling neutral lock groove 616 in subsequent FIG. 6C.

Lock 512 is screwed to the exterior container wall, but through four vertical slits in lock 512 that allows it minor displacement. It also has a vertically oval opening through which the end of shaft 522 protrudes. Shaft 522 has two circumferential grooves towards its end. This gives shaft 522 two alternate forward settings in addition to its most advanced forward setting where knob combo 524 is flush with lock 512, save a washer separating the two.

FIG. 5F furthermore shows low profile shaft support blocks 534 and high profile shaft support blocks 536. Both are wood blocks cut from linear lumber routed to be inserted into and to be retained by the channels in the modular container panel profiles. The shafts rotate in flanged bearings that are attached to the tops of the routed wood blocks by straps having some of their screws into the blocks and some into the panel profiles. As such the support blocks are stable, inexpensive, height customizable and do not require welding. A stronger but more costly alternative to woodblocks is metal supports for the flanged shaft bearings that are needed for heavier loads.

FIGS. 6A through 6I are orthogonal views of the three alternative coupling settings for manipulating and locking container legs extension and retraction for self-loading.

The settings are shown from the bottom to better see the worm-to-worm gear interaction. Moving between settings requires advancing or retracting coupling operating shaft 522 by rotating coupling operating knob and thrust ball bearing combo 524, because the worms on shaft 522 are helically restrained by the worm gears on shafts 518 and 520.

FIG. 6A shows the most forward positioned coupling setting here termed Engaged. Detailed FIG. 6B shows coupling operating shaft front worm 528 cooperating with front coupling shaft worm gear 526 and coupling operating shaft rear worm 532 cooperating with rear coupling shaft worm gear 530. Detailed FIG. 6C shows coupling operating shaft 522 where both coupling neutral lock groove 616 and coupling front lock groove 614 are unused and visible. In this setting, knob combo 524 is hidden by lock 512.

FIG. 6D shows the middle coupling setting here termed Front Lock. Detailed FIG. 6E shows worm 528 cooperating with worm gear 526, but worm 532 no longer cooperating with worm gear 530. Detailed FIG. 6F shows coupling operating shaft 522 where coupling neutral lock groove 616 is still unused and visible, but where coupling front lock groove 614 is in use and no longer visible. In this setting, knob combo 524 and washer 618 are visible. The face of worm 528 needs to be twice the length of worm 532.

FIG. 6G shows the least forward positioned coupling setting here termed Neutral. Detailed FIG. 6H shows worm 528 no longer cooperating with worm gear 526, and worm 532 no longer cooperating with worm gear 530. Detailed FIG. 6I shows coupling operating shaft 522 where coupling neutral lock groove 616 is in use and no longer visible, and where coupling front lock groove 614 is no longer in use, but now visible on the other side of lock 512. In this setting, knob combo 524 and washer 618 are still visible.

The manipulation possible with the three coupling settings described above is summarized as follows:

The Neutral coupling setting is used when only the rear legs or only the front legs must be moved vertically. That was demonstrated in previous FIGS. 1D and 1F of the loading or unloading sequence. In this coupling setting, external power can be applied to either front legs operating shaft 514 or rear legs operating shaft 510. The rotational power is directly applied without any speed reducer gearing. That is fast and ideal because leg extension in the neutral setting involves no load bearing other than the weight of the legs themselves.

The Front Lock setting is used when only the rear legs are moved vertically while the front legs must be locked in their extended position as previously illustrated in FIG. 1D.

The Engaged setting is the default coupling setting and used when the rear and front legs are moved in unison. That was demonstrated in previous FIG. 1B of the loading or unloading sequence. In this coupling setting, external rotational power is applied only to the coupling operating shaft. The rotational power is applied via worms to worm gears, which significantly reduces front and rear operating shaft rotating speed, but increases their torque and cargo lifting power. That is also ideal because leg extension in the Engaged setting most often involves significant load bearing, or weight lifting.

A second advantage of using worm-to-worm gear power transfer is the inability to reverse the direction of power. This means that the Engaged setting automatically locks the legs in their positions when power is not applied to coupling operating shaft 522. It even locks all legs if power is mistakenly applied to either the rear or front legs operating shafts 510 or 514 while in the Engaged coupling setting.

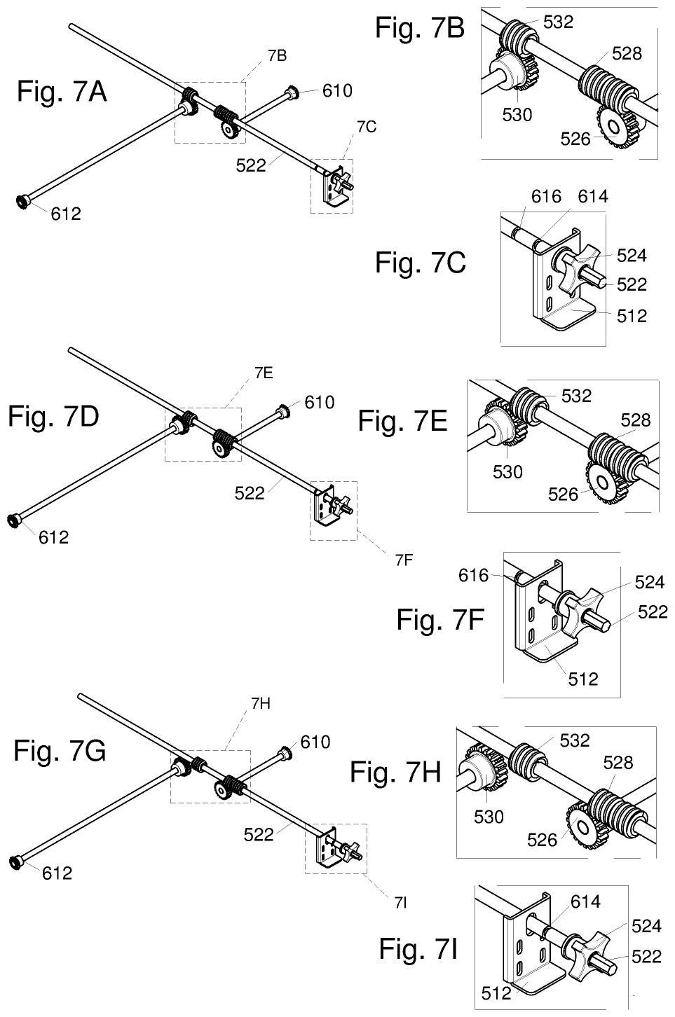

FIGS. 7A through 7I are perspective views of the three alternative coupling settings for manipulating and locking container legs extension and retraction for self-loading.

FIGS. 7A, 7B and 7C are perspective views of FIGS. 6A, 6B and 6C, respectively.

FIGS. 7D, 7E and 7F are perspective views of FIGS. 6D, 6E and 6F, respectively.

FIGS. 7G, 7H and 7I are perspective views of FIGS. 6G, 6H and 6I, respectively.

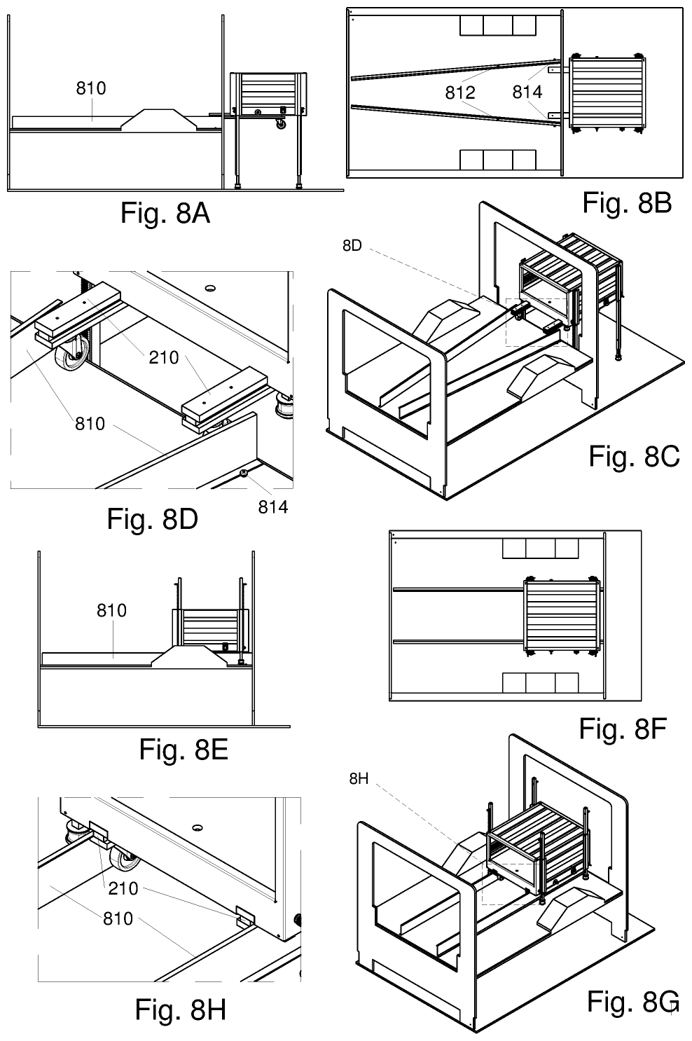

### Operation—Securing Container in Vehicle—FIGS. 8A Through 8H

FIGS. 8A through 8H are orthogonal and perspective views of container self-loaded into a van with an insertable cargo surface and retained by rails pivoting on said surface.

FIG. 8A is the same loading step as already shown in FIG. 1C with one exception. FIG. 8A shows the addition of container in-vehicle retainer rails 810. In FIG. 8B, rails 810 are seen from the top. As shown, support rails 210 of container have dropped their first set of casters just inside on vehicle loading floor. Rails 810 hide these casters here. At this stage of loading, the rear ends of retainer rails 810 are spread outwards by container support rails 210, thereby forcing ample side tolerances for receiving the container. Rails 810 pivot around retainer rail pivot bolts 812 with retainer rail stop bolts 814 limiting their outwards spread. Bolts are mounted on an insertable and removable vehicle cargo floor, most preferable and economical of plywood.

FIG. 8C is a perspective view of orthogonal FIGS. 8A and 8B. Detailed FIG. 8D clearly shows the top retaining edges of rails 810, as well as stop bolts 814.

FIG. 8E is the same loading step as already shown in FIG. 1G, but here also showing container in-vehicle retainer rails 810. In FIG. 8F, rails 810 are seen from the top. As the container advances onto vehicle cargo floor, support rails 210 gradually force pivoting retainer rails 810 together to finally become parallel. At this point, rails 810 will vertically and horizontally enclose and retain the bottom of container support rails 210 with casters against the inserted vehicle cargo floor as shown in FIG. 8G and detailed in FIG. 8H.

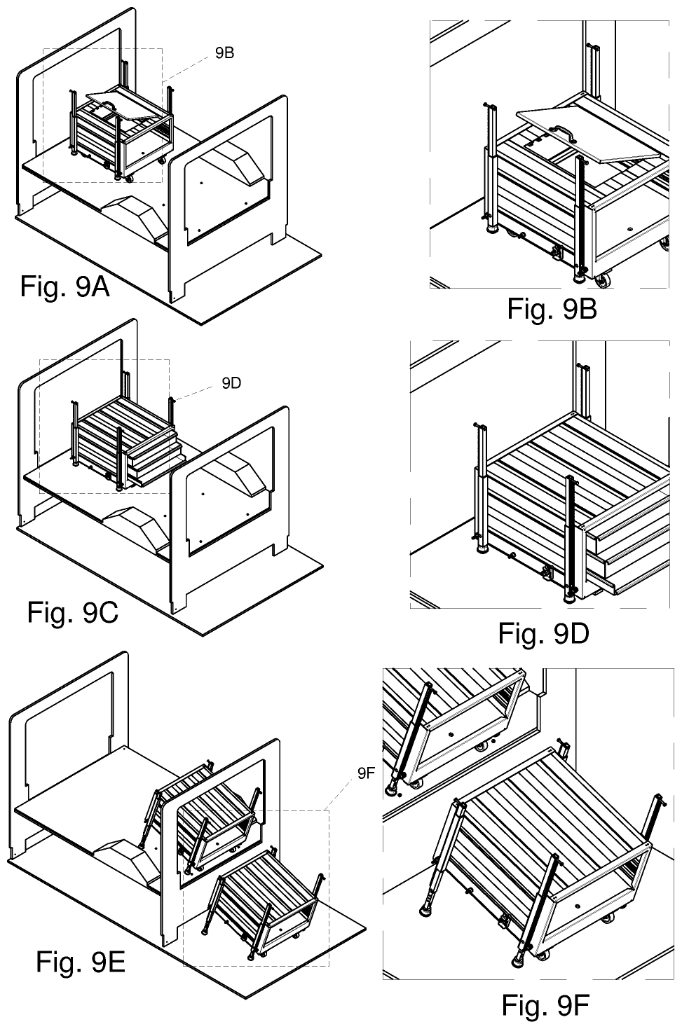

### Description—Embodiments and Ramifications—FIGS. 9A Through 10F

FIGS. 9A through 9F are perspective views of self loading containers with alternative functions and uses. They exemplify other ramifications of self loading container.

FIG. 9A shows a container loaded into a van. Further detailed in FIG. 9B, this container has a top opening with a hinged lid. Similar exterior customizations can include: Open or closed front and rear end framing, hinged or sliding front, rear and side doors, integration with exterior wall surfaces for decorative, promotional or moisture proofing purposes, the attachment of handles or of other components including other containers.

FIG. 9C and detailed FIG. 9D include two drawers in the top of the container and a sliding shelf in its bottom. Similar interior container customizations can include: Removable shelving, insulation and dunnage components, mechanical, electrical and ventilation components, optionally using the channels in the wall panels as ducting.

FIG. 9E and detailed FIG. 9F show a container tilted for slidingly unloading of bulk materials from its front end. The tilt is achieved by lowering the container rear legs, thereby elevating the rear of container to the desired tilt position, while leaving its front legs retracted, or lowered less than its rear legs.

FIGS. 10A through 10E are perspective views of self-loading platforms with alternative functions and uses. They exemplify other embodiments of self-loading container.

FIG. 10A shows self-loading platform on ground ready to load and another already loaded into cargo van.

FIG. 10B shows self loading platform with its loading ramp down. FIG. 10C shows it with its ramp up, ready to load into vehicle.

FIG. 10D shows self loading platform with its legs fully retracted upon which is mounted an open top standard container. FIG. 10E shows it with its legs extended.

### INDUSTRIAL APPLICABILITY

It is the object of the above-described container to bring self-loading capabilities to a range of products so far loaded for transportation manually or by external equipment. It is achieved by improving upon the existing technology of industrial shipping containers to arrive at a simpler, safer and less costly operation of self-loading containers and container-like products for more general use. A further object is to simplify the customization of such products with a range of ramifications and embodiments for alternative sizes, shapes and uses. Finally to do so in capital cost effective ways, both for the manufacturers, product customizers and end users of self-loadable products.

One major advantage of the present container over prior art is the improvement of operating stability by the lowering of container center of gravity. This is achieved by the use of support rails under the container that carry the main rolling means, not on vertically extended legs. Horizontally extendable, the support rails also facilitate and guide the loading and unloading of objects into and out of vehicle cargo floors or onto fixed surfaces such as loading docks. Optional vehicle cargo floor retainer rails that automatically pivot to guide and secure loaded containers in place can retain container support rails.

Another major advantage over prior art is the lower cost and simplification of the container coupling system for manipulating the vertical movement of legs that raise and lower container. With one of three manual settings, the proposed coupling can cause both front and rear legs to move in unison with a highly increased shaft torque for heavy loads, or alternatively lock them in place at any given height. With a second setting, the coupling can lock only the front legs in place while allowing the height of the rear legs to be separately manipulated. With a third setting, both front and rear legs can be separately manipulated. A battery powered drill is the simplest manipulation means to rotate shafts. Internal electric motors and hydraulics are needed for heavier loads

A more general advantage of the present container is its optional use of an assembly system with modular components that facilitate container customization as to size, shape and use. The system, which is the subject of another patent application by the same inventor, also facilitates the integration of alternative mechanical customizations of the present container. Another advantage of the system is its reversible integration of third party products for customization of container exteriors and interiors without welding. Welding can deform and mar parts, preventing recycling.

Anticipated and targeted uses include industrial, commercial and consumer. At one end of the user spectrum are one-person entrepreneurs who must often load and unload heavy cargo by themselves. Particularly so, if they routinely need to convert their only family vehicle to and from entrepreneurial uses. At the other end of the user spectrum are vehicle fleets of corporate and franchise chains employing individual drivers on routes that require continuous loading and unloading of heavy cargo units. Consumer uses may range from self-loading catering carts to van conversions and many more in between.

While the invention herein disclosed fulfills the objects stated above, and while examples of alternative ramifications and embodiments have been shown, it will be appreciated that numerous other modifications and embodiments may be devised by those skilled in the art, and it is intended that the appended claims cover all such modifications and embodiments as fall within the true spirit and scope of the present invention.

What is claimed is:

1. A self-loading container having its main rolling means fixed to horizontally extendable support rails that are slidingly incorporated in the exterior bottom of said container, comprising:
a. means of mechanically extending and retracting said rails horizontally, and
b. means of mechanically elevating and lowering said container vertically,
whereby said container can be vertically maneuvered from a starting level to a receiving level or surface and then be horizontally maneuvered onto said receiving surface, where it can further be routinely maneuvered horizontally while resting on its said main rolling means.

2. The container of claim 1, wherein said means of claim 1a comprise:
a. a rotatable horizontal shaft, perpendicular to said horizontally extendable support rails, said shaft having spur gears mounted that cooperate with gear racks horizontally embedded in the top surface of said support rails, so when said shaft is rotated, said support rails extend or retract, and
b. horizontal longitudinal channels integrated in the exterior bottom of said container, said channels able to vertically and horizontally retain said support rails while they are slidingly extended or retracted, and
c. motion stops to limit the extension range of said support rails, and
d. container end frames, at least one of which has cutouts through which said support rails can be extended or retracted,
whereby the operating center of gravity of said container is lowered to ensure its structural stability, its horizontal manipulation simplified, its horizontal transfer made possible even to surfaces or vehicles with protruding bumpers or other features, and said main rolling means made exchangeable by inserting a different set of extendable support rails carrying alternate rolling means.

3. The container of claim 1, wherein said means of claim 1b comprise:
a. container front and rear legs that can selectively be extended, retracted or locked in pairs, or in unison, the respective choice of which is governed by the horizontal forward setting of a coupling operating shaft perpendicular to, and with its one end accessible from, the exterior side wall of said container, said shaft retained by one bearing in said container exterior side wall and at least one bearing mounted in the interior of said container, said interior bearing aligned with the other end of said shaft, and
b. said coupling operating shaft of claim 3a having three forward settings, each of said settings selected by manually rotating an exterior coupling operating knob on the end of said shaft thereby causing worms mounted on said shaft in the interior of said container to helically interact with worm gears mounted on perpendicular interior shafts, whereby said knob can be set off from said exterior side wall of said container at alternate distances determined by the number of turns applied to said knob, and
c. the default setting termed engaged is the most forward positioned of said three forward settings of claim 3b, where said exterior knob on said coupling operating shaft abuts a coupling interval lock that is slidingly mounted on the exterior of said wall with only a coupling operating shaft washer between them, and
d. the intermediate forward setting termed front lock is selected by dialing back said operating knob to separate it from said interval lock by a predetermined distance, whereupon this setting can be secured in place by vertically displacing said interval lock to engage with a corresponding circumferential groove in said coupling operating shaft serving as a forward motion stop for said shaft, and
e. the least forward positioned setting termed neutral is selected by further dialing back said operating knob to separate it from said interval lock by a further predetermined distance, whereupon this setting can be secured in place by vertically displacing said interval lock to engage with another corresponding circumferential groove in said coupling operating shaft serving as a second forward motion stop for said shaft, and
f. said container rear legs of claim 3a, the vertical extension of which can optionally and temporarily be locked in place with an exterior leg lock, and
g. said container front and rear legs of claim 3a, the length of which can be adjusted in real time as may be required by the vertical loading distance between said starting and receiving surfaces and as may further be required by headroom height limitations of said receiving surface, and
h. said container front and rear legs of claim 3a that provide for both top and bottom motion stops to limit their vertical movement, and
i. said container front and rear legs of claim 3a that can optionally accept auxiliary rolling means attached to their bottoms that do not need to be detached when legs are retracted above the container bottom level as is needed for self loading,
whereby the use of extendable legs can be a stable, precise and effective way to change the vertical level of said self-loading container for the purpose of then horizontally transferring said container onto a receiving surface, but attaching the main rolling means of container to its extendable legs as in prior art is not a structurally stable way for its weight bearing movement on horizontal surfaces.

4. The coupling operating shaft of claim 3 wherein its manipulative gearing comprises:
a. two worms mounted on the interior of said operating shaft at predetermined distances from each other and from said exterior sidewall of container, the one of said worms closest to said wall termed coupling operating shaft front worm able to cooperate with a front coupling shaft worm gear in the end of a horizontal frontward facing front coupling shaft and the other of said worms termed coupling operating shaft rear worm able to cooperate with a rear coupling shaft worm gear in the end of a horizontal rearward facing rear coupling shaft, both of said front and rear coupling shafts perpendicular to said coupling operating shaft, and
b. said frontward facing coupling shaft having in its other end a miter gear that cooperates with a miter gear mounted on a horizontal front legs operating shaft perpendicular to said frontward facing coupling shaft, and
c. said rearward facing coupling shaft having in its other end a miter gear that cooperates with a miter gear mounted on a horizontal rear legs operating shaft perpendicular to said rearward facing coupling shaft, and
d. said front legs operating shaft having a length that exceeds the width of said container of claim 1 with said operating shaft supported by bearings in both exterior sidewalls of said container and with each exterior end of said shaft having spur gears mounted that cooperate with vertical exterior racks attached to said extendable front legs of claim 3a, and
e. said rear legs operating shaft having a length that exceeds the width of said container of claim 1 with said operating shaft supported by bearings in both exterior sidewalls of said container and with each exterior end of said shaft having spur gears mounted that cooperate with vertical exterior racks attached to said extendable rear legs of claim 3a.

5. The container of claim 1 thus having a coupling operating shaft, a front legs operating shaft and a rear legs operating shaft, all said shafts with ends operable from the same said exterior sidewall of said container, said ends all hexagonally shaped to accept attachment of an exterior power source that can transfer rotational power to either one of said shafts, and said coupling operating shaft having three distinct forward settings, respectively termed engaged, front lock, and neutral, the consequent manipulative gearing options of said container comprise:
a. said engaged forward setting of said coupling operating shaft, whereby there is cooperation between said coupling operating shaft front worm and said front coupling shaft worm gear of claim 4a and cooperation between said coupling operating shaft rear worm and said rear coupling shaft worm gear, and whereby rotation of said coupling operating shaft in said engaged setting will cause said front legs operating shaft and said rear legs operating shaft to be rotated in unison, and thereby elevating or retracting the front legs and the rear legs in unison, and whereby said worm to worm gear power transfer decreases speed of rotation of said front and rear leg operating shafts, but increases their torque and thereby increases the weight lifting capacity of all four said container legs, and
b. said engaged forward setting of said coupling operating shaft, whereby both front and rear legs will be locked in their respective vertical positions or elevations when said coupling operating shaft is not rotated, because worm to worm gear rotational power transfer is only possible in one direction and not in the reverse direction, and
c. said front lock forward setting of said coupling operating shaft, whereby there Is cooperation between said coupling operating shaft front extended face worm and said front coupling shaft worm gear, but no cooperation between said coupling operating shaft rear worm and said rear coupling shaft worm gear, thereby allowing said front legs operating shaft and front legs to be locked in place while said rear legs operating shaft can still be rotated and rear legs moved vertically, said front lock setting being needed in every self-loading sequence of steps, and
d. said neutral forward setting of said coupling operating shaft, whereby there is no cooperation between said coupling operating shaft front worm and said front coupling shaft worm gear of claim 4a and no cooperation between said coupling shaft rear worm and said rear coupling shaft worm gear, thereby allowing said front legs operating shaft and said rear legs operating shaft to be rotated independently of each other, and thereby extending or retracting in pairs either said front legs or said rear legs independently of each other,
whereby the selected forward setting of said coupling operating shaft can govern whether rotation of the container front legs and rear leg operating shafts and the resulting vertical movement of its front and rear legs will be independent of each other or in unison, and whether vertical movement of both front and rear legs will be locked in unison and when said coupling operating shaft is in its neutral forward setting, thereby allowing container front and rear legs to be moved independently, while each pair can also be externally locked in place.

6. An insertable and retractable vehicle cargo floor with retainer channels that when said container of claim 1 is self-loaded onto said cargo floor are horizontally pivoted open by the advancing of said extendable support rails of claim 1 thereby providing a wide bridge head for initially depositing said main rolling means of said container, said means mounted on said horizontally extended support channels and as said container is further advanced onto said cargo floor, it is guided by said retainer channels, that are automatically forced by said support rails to gradually pivot towards becoming parallel in a position where they enclose, and vertically and horizontally retain, said support channels of said container,
whereby containers can automatically be guided in place on vehicle cargo floors and automatically be safely retained during transport and travel.
